(19) United States
(12) Patent Application Publication
(10) Pub. No.: US 2007/0121330 A1
(43) Pub. Date: May 31, 2007

(54) LAMP SHADE SYSTEM

(75) Inventor: Mark Joseph, Aspen, CO (US)

Correspondence Address: GLENN L. WEBB, P.O BOX 951, CONIFER, CO, 80433, US

(73) Assignee: LITESNOW LLC, Aspen, CO (US)

(21) Appl. No.: 11/164,658

(22) Filed: Nov. 30, 2005

(51) Int. Cl. F21V 11/00

(52) U.S. Cl. 362/351

(57) ABSTRACT

A system for providing unique lamp shades for lighting fixtures. The system includes a light fixture ring that is mountable over a light bulb or onto a light fixture. The light fixture ring includes a series of outwardly extending posts that engage a lamp shade cover. The lamp shade cover may be provided from the manufacturer, created from templates or designed by the user.

### FIELD OF THE INVENTION

The present invention relates to shades for indoor lighting fixtures.

### BACKGROUND OF THE INVENTION

Lamp shades have been in use for many hundreds of years since the inception of indoor lighting. Lamp shades are used to create softer ambient illumination in a specified area. These shades have also been used to display decorative fashion incorporated in the shade itself through colors, patterns, shapes and designs. Lamp shades are typically mounted to a frame that is suspended from some part of the lighting fixture. The lamp shade frame may be as simple as a wire clamp that attaches to a light bulb. The lamp shade is mounted during the manufacturing process to the frame and purchases as a whole.

Another lamp shade attachment uses a wire frame that includes an upper and lower circle-shaped wire, each connected to the other by several rigid wires running between them. The shade is wrapped around the space framed by the upper and lower elements, and thus light is filtered through the material of the shade. The lower circle-shaped element is typically larger in diameter than the upper circle-shaped element, thereby allowing minimal light to be directed from the top of the shade, and more illumination directly below the bulb through the opening created by the larger diameter of the lower circle-shaped element.

Other lamp shade attachments use glass or plastic globes that are mounted over a light bulb to a fixture. The globe is attached to the fixture by clamping screws. The entire globe must be replaced in order to change the aesthetic appearance of the lamp shade or if damage occurs.

Most of these shades are manufactured and supplied by the manufacturer or supplier of the lighting fixture. Some systems have been disclosed which allow a user to create their own lampshade. One of these systems is disclosed in U.S. Pat. No. 1,537,777. The obvious disadvantage of this system is that the user must align the various layers of material directly on the shade structure, which then must be bent at various points to carefully adhere the opposing ends. Another disadvantage of this method is the requirement of mounting to an existing frame. Due to these disadvantages, significant time must be spent assembling the shade each time a design is created or modified.

Another early method for creating a shade is disclosed in U.S. Pat. No. 1,580,922. This method also relies on an existing frame for assembly, and significantly limits the user with the style and shape of the design or pattern. U.S. Pat. No. 1,583,568 also discloses a similar method. The disadvantages previously mentioned are all contained in this method as well.

Other systems more recently have tried to overcome these disadvantages by providing a pattern piece for configuring the design or pattern to be employed with the actual shade. One such system is disclosed in U.S. Pat. No. 5,211,474. However, this method limits the shape of the shade and thereby limits the direction of the illumination for the corresponding lamp by requiring mounting on a standard lamp frame. This method also is limited by incorporating a fabric material for the shade and a stiff material for the pattern, which is difficult to manipulate in order to fit correctly with the frame.

Another such system is disclosed in U.S. Pat. No. 6,398,390. This system uses a plurality of bars, cords and panels to allow the user to modify the color, pattern or graphic design from one panel to the next. The disadvantages of this system include the complexity of the assembly and the relatively inflexible structure. Although the user now has more options when it comes to creative design, there are still limitations in the size, shape, and direction of mounting the shade.

Further methods have included the application of a separate surface on top of the original lampshade to allow decoration and customization. Two such systems are disclosed in U.S. Pat. Nos. 4,068,120 and 5,662,412. The only area that these two methods distinguish themselves is by allowing the user to modify a first surface, and then attach it to a second surface which may be pre-attached to a frame. These methods have the disadvantage of an even heavier surface, and require extra time to align the first surface adjacent to the second surface.

Another disadvantage of the prior art is the reduced ability to perforate the material composing the shade. Most of the materials disclosed by the prior art do not allow perforations due to the thick or delicate material that is employed in the construction of the shade. These methods also fail to disclose a method for creating unique shapes with material as a lampshade. Many of these prior art methods involve a large number of components and are therefore more expensive than purchasing a standard lampshade and decorating it without a kit.

Thus there is a need for a lamp shade system that allows a user to easily attach a lamp shade to a light fixture, to easily change the lamp shades as desired and to create their own unique designs for lamp shades.

### SUMMARY OF THE INVENTION

The present invention solves these problems and others by providing a unique system for creating a custom shade for a variety of lighting fixture styles. The system allows the user to select from existing designs or to create their own design. The system provides a unique lamp shade cover mounting fixture that allows the lamp shade covers to be easily installed and removed.

In a preferred embodiment of the present invention, the system provides a unique lamp shade cover mounting fixture. The mounting fixture in this preferred embodiment provides a mounting ring. The mounting ring has an inner diameter that attaches over a light bulb stem or onto the light fixture. It is secured there by engagement with the light bulb stem or light fixture. Alternatively, mounting ring may use clamping screws or an adhesive layer to secure it in place. The exterior surface of the mounting ring has an engagement mechanism for securing the lamp shade cover. In one preferred embodiment, this engagement mechanism is a series of outwardly extending posts that engage in perforations in the lamp shade cover. These perforations allow the lamp shade cover to be simply engaged onto the mounting ring and removed as desired.

Another preferred embodiment of the present invention provides the user with a plurality of lamp shade cover designs. The user selects a preferred design and secures it onto the mounting ring. The designs can be changed quickly and easily as desired.

Another preferred embodiment of the present invention provides the user with a plurality of templates. The user selects a desired template, traces the design onto blank lamp shade cover material and cuts out the traced design. This design can then be mounted onto the mounting ring.

Another preferred embodiment of the present invention provides the user with the ability to create their own design of a lamp shade cover. The user creates a design with a sheet of material, such as paper. Once the design has been created by cutting, slitting, perforation, folding or other techniques, this design is transferred onto a sheet of lamp shade cover material and cut out. The final design can then be easily installed onto the mounting ring.

These and other features of the claimed inventions will be evident from the ensuing detailed descriptions of preferred embodiments and from the drawings.

### BRIEF DESCRIPTION OF THE DRAWINGS

FIG. 1 is a perspective view of the apparatus described in the preferred embodiment.

FIG. 2 is a detail view of the mounting ring described in the preferred embodiment.

FIG. 3 is a perspective view of the mounting ring of the embodiment of FIG. 1 mounted on a light fixture.

FIG. 4 is a plan view of the lamp shade cover of the embodiment of FIG. 1.

FIG. 5 is a plan view of a template design on a lamp shade cover material sheet.

FIG. 6 is a perspective view of another lamp shade cover using the mounting ring of the embodiment of FIG. 1.

FIG. 7 is a perspective view of another lamp shade cover using the mounting ring of the embodiment of FIG. 1.

### DETAILED DESCRIPTION OF PREFERRED EMBODIMENTS

The present invention provides a unique lamp shade attachment design as well as lamp shade designs. The present invention enables users to customize their own designs in lamp shades. These lamp shades may be used with most lamp fixtures and particularly with low voltage and/or halogen light fixtures. Preferred embodiments of the present invention are discussed in greater detail below. It is to be expressly understood that this exemplary embodiment is provided for descriptive purposes only and is not meant to unduly limit the scope of the present inventive concept. Other embodiments, and variations of the shapes, designs, or patterns created by the shade, or the style of lighting fixtures of the present invention are considered within the present inventive concept as set forth in the claims herein. It is to be expressly understood that other devices are contemplated for use with the present invention as well.

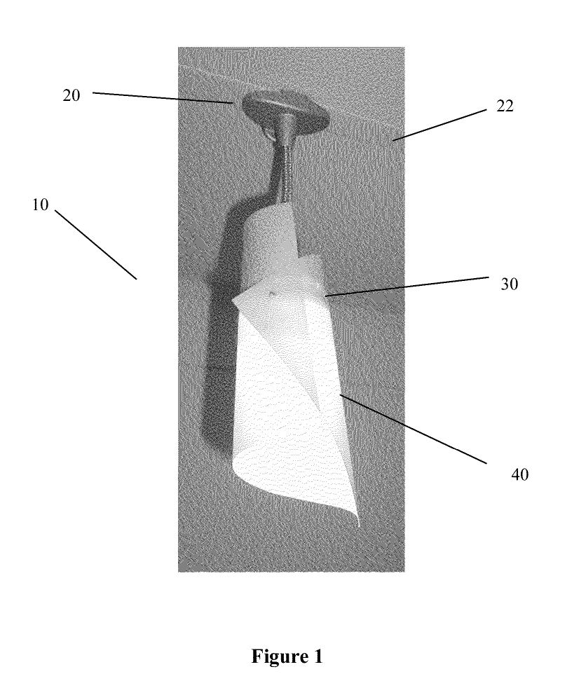

A preferred embodiment of the present invention is illustrated in FIGS. 1-4. The lamp shade system 10 of this preferred embodiment is illustrated for use on a light fixture 20 attached to a track lighting system 22, such as the light fixtures and track lighting systems disclosed in pending applications Ser. No. 10/905,220, filed on Dec. 22, 2004 and Ser. No. 10/378,460, filed on Feb. 3, 2003, both incorporated herein by reference. It is to be expressly understood that the lamp shade system of this and other embodiments may be used with other types of light fixtures and light systems.

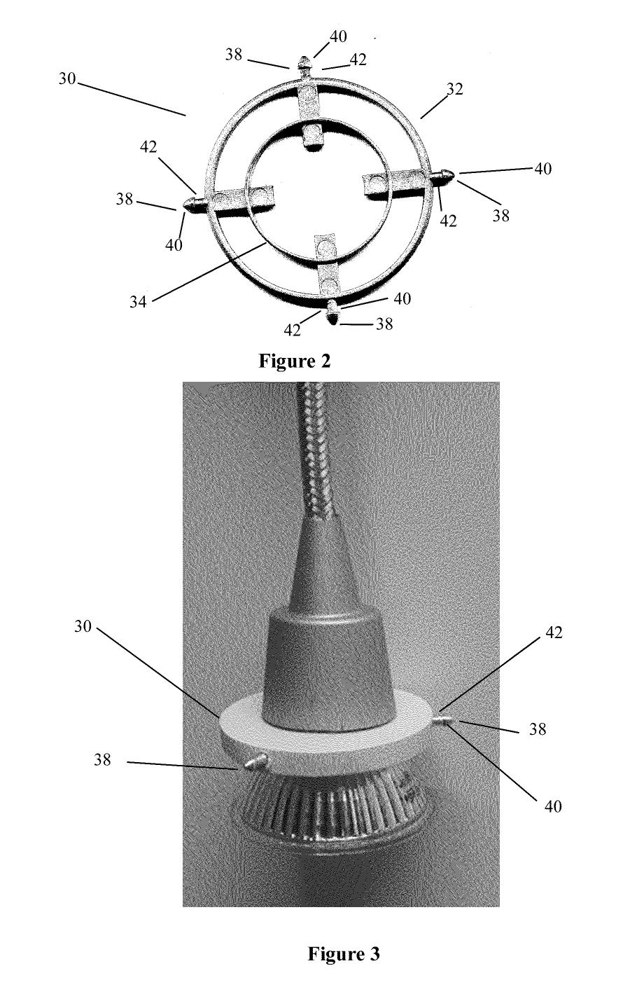

The lamp shade system 10 of this preferred embodiment includes a fixture ring 30 and lamp shade cover 50. The fixture ring 30, as shown in FIGS. 2 and 3 is a substantially circular component. In this preferred embodiment, the ring 30 is a plastic component but could be formed from other materials if desired. The ring 30 includes an exterior surface ring 32 and an inner fixture ring 34. While these two rings are illustrated as separate rings connected to one another, they could be integrated as a single ring. The diameter of the inner fixture ring 34 is selected to allow the fixture ring 30 to fit over the neck of a light bulb, as shown in FIG. 3. Inwardly extending members 36 may be used to provide a snug fit. These members may be trimmed if necessary to accommodate large sizes of bulbs. Different rings having different diameters of the inner fixture ring 34 may also be provided to accommodate other sizes of light bulbs. Also, the diameter of the inner fixture ring 34 may be selected to allow the fixture ring to mount over a portion of the light fixture as well. In another embodiment, the inner ring may use clamping screws to allow the light fixture ring to be mounted on other surfaces of the lamp fixture.

The exterior surface ring portion 32 of the light fixture ring 30 includes a plurality of outwardly extending post members 38. In this preferred embodiment, the projection members include a substantially tapered portion 40 with a recess 42 formed adjacent the tapered portion. The tapered portion 40 is used as a piercing member as discussed below. In alternative embodiment of this embodiment, the tapered portion may be formed with a snap or clip attached thereto to secure the lamp shade cover as discussed below.

It is to be expressly understood that the exterior surface of the light fixture ring is not limited to a circular shape. Other shapes such as square, triangular, or any other geometrical shape may be used as well.

In this preferred embodiment, the light fixture 30 is assembled onto the light fixture by sliding over the socket end of the light bulb. The light bulb is then inserted into the light fixture, as shown in FIG. 3. This provides a secure engagement between the light fixture and the light fixture ring.

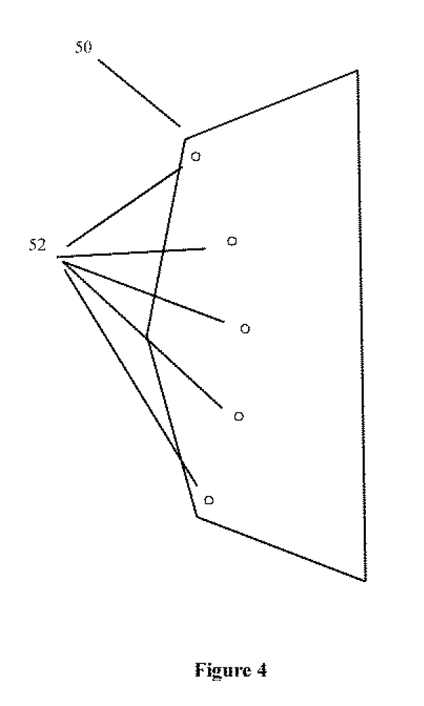

The lamp shade cover 50 is formed from any flexible lamp shade material, preferably a heat resistant material or other suitable material. The lamp shade cover 50 as shown in FIG. 4 includes perforations 52 that engage over the post members 38 of the lamp shade fixture ring 40. Preferably, the perforations are slightly undersize so that the material surrounding the perforations stretch over the tapered portion 40 and resume their normal size in the recess 42. This secures the lamp shade cover to the lighting ring fixture. Alternatively, snaps or clips or other fasteners may be used to secure the lamp shade cover to the fixture ring.

The lamp shade cover in another preferred embodiment may be provided as a do it yourself alternative. A number of different designs of lamp shade covers may be provided by a manufacturer. These designs may include different designs, shapes, colors, patterns, or other distinguishing characteristics. The user simply selects the particular design and installs on the lighting fixture ring 30. This allows the user to change designs without purchasing an entire lamp shade or lighting fixture. This is particularly useful for decorators and designers to satisfy their clients. The lamp shades can be updated as desired. The commonality of these designs are the perforations 52. Alternatively these perforations may be formed in any material with the appropriate tool. In an alternative embodiment, the lamp shade systems are provided with a tool that creates the perforations uniformly.

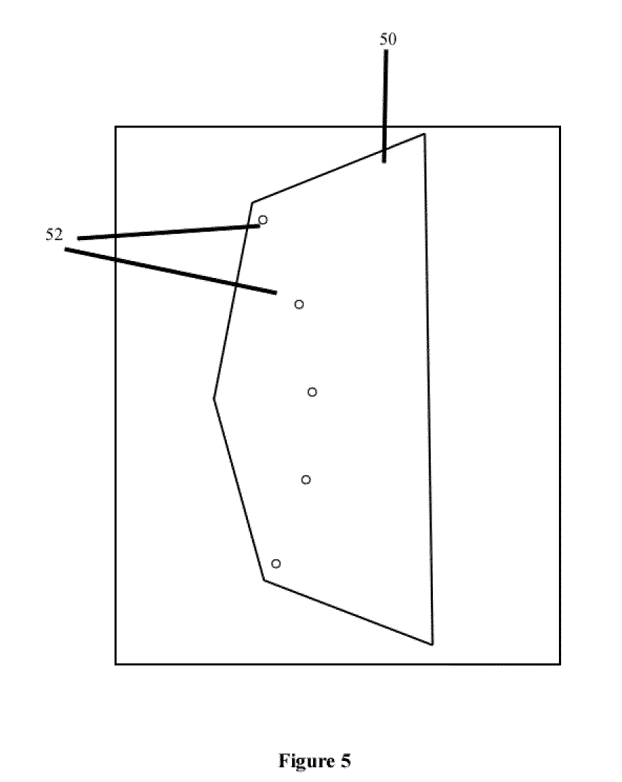

Another preferred embodiment of the present invention provides the ability of a user to design their own lamp shade cover. This preferred embodiment provides a series of templates and lamp shade cover materials to the user. The user selects their desired design from the templates. The design is then traced from the template onto the lamp shade cover material as shown in FIG. 5. The traced design is then cut with scissors or a knife. The perforations 52 can be formed by the user or simply punctured by the tapered portions 40 of the post members 38 of the light fixture ring.

The user may also create their own unique designs with this preferred embodiment. The user can experiment with designs with a sheet of ordinary paper. The sheet can be modified by cutting, perforating, bending, folding, coloring, marking or other modifications. Once the shape of the design has been created as well as any patterns or apertures formed in the lamp shade design, these can be traced onto a sheet of lamp shade cover material. The traced design can be cut out and installed onto the light fixture ring 30.

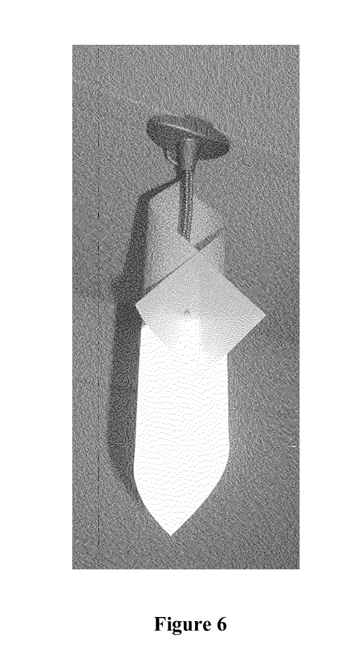

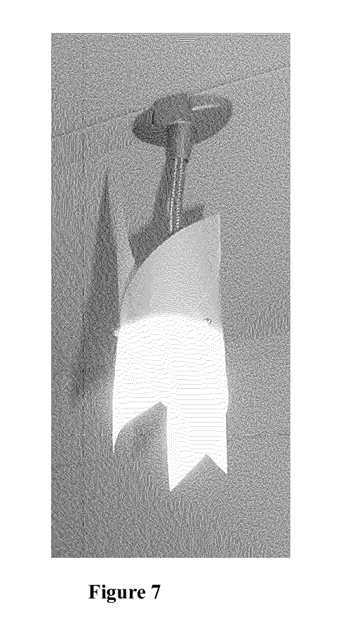

Different designs can be easily achieved, as shown in FIGS. 1, 5 and 6. These are provided merely as examples of what may be created. Other designs are certainly within the scope of the claimed inventions.

As will be understood by those familiar with the art, the present invention may be embodied in other specific forms without departing from the spirit or essential characteristics thereof. For example, the present invention is not limited in the number or type of material that may be attached to the mounting ring device. Accordingly, the disclosure of the preferred embodiment of the invention is intended to be illustrative, but not limiting, of the scope of the invention which is set forth in the following claims.

What is claimed is:

1. A system for attaching lamp shades to a lamp fixture, said system comprising:
a light fixture ring;
an inner diameter on said light fixture ring for installation over the narrow portion of a light bulb;
an outer surface on said light fixture ring; and
a plurality of outwardly extending post member for engagement with a lamp shade cover material to secure the lamp shade cover material to said light fixture ring.

2. The system of claim 1 wherein said outwardly extending post members include:
a tapered portion to provide a piercing action into said lamp shade cover material.

3. The system of claim 1 wherein said outwardly extending post members include:
a recessed portion to receive said lamp shade cover material.

4. The system of claim 1 wherein said system includes:
said lamp shade cover material is provided in a plurality of designs.

5. The system of claim 1 wherein said system includes:
sheets of lamp shade cover materials; and
at least one template wherein a user may trace the design of a template on said sheets of lamp shade cover materials to create a lamp shade cover.

6. The system of claim 1 wherein said system includes:
sheets of lamp shade cover materials wherein a user may create their own design for a lamp shade cover.

7. The system of claim 1 wherein said system further includes:
said light fixture ring is mountable on the light fixture itself.

8. A method for creating a lamp shade, said method comprising the steps of:
providing a light fixture ring having a plurality of outwardly extending post members;
mounting said lamp fixture ring on a light fixture; and
mounting a lamp shade cover onto said light fixture ring by engagement onto said outwardly extending post members.

9. The method of claim 8 wherein said method further comprises the steps of:
selecting said lamp shade cover from a plurality of lamp shade cover designs.

10. The method of claim 8 wherein said method further comprises the steps of:
designing a lamp shade cover from a series of templates;
tracing said design from a selected template onto lamp shade cover material; and
cutting out said traced design from said lamp shade cover material.

11. The method of claim 8 wherein said method further comprises the steps of:
creating a lamp shade cover design from a sheet of material;
tracing said design onto lamp shade cover material; and
cutting out said traced design from said lamp shade cover material.
